(19) United States
(12) Patent Application Publication
(10) Pub. No.: US 2008/0027162 A1
(43) Pub. Date: Jan. 31, 2008

(54) Silica reinforced rubber composition and use in tires

(76) Inventors: Kuo-Chih Hua, Richfield, OH (US); Shingo Futamura, Wadsworth, OH (US); Wen-Liang Hsu, Cuyahoga Falls, OH (US); Paul Harry Sandstrom, Cuyahoga Falls, OH (US)

Correspondence Address: THE GOODYEAR TIRE & RUBBER COMPANY;INTELLECTUAL PROPERTY DEPARTMENT 823, 1144 EAST MARKET STREET, AKRON, OH, 44316-0001, US

(21) Appl. No.: 11/492,622

(22) Filed: Jul. 25, 2006

(51) Int. Cl. B60C 1/00; C08K 3/22

(52) U.S. Cl. 524/262; 524/571; 524/432; 524/322

(57) ABSTRACT

This invention relates to the preparation of silica-rich rubber compositions which contain silica reinforcement and silica coupler together with a specified combination of zinc oxide and long chain (fatty) carboxylic acid such as stearic acid. The silica, silica coupling agent, zinc oxide and stearic acid are combined in a manner to form a complex network. The silica is a precipitated silica in a form of silica aggregates which contain hydroxyl groups on its surface. A preferred silica coupling agent is a bis (3-trialkoxysilylalkyl) polysulfide which contains an average of from 2 to about 4, preferably from 2 to about 2.6, connecting sulfur atoms in its polysulfidic bridge. The invention further relates to tires having a component thereof such as, for example, a tread.

### FIELD OF THE INVENTION

This invention relates to the preparation of silica-rich rubber compositions which contain silica reinforcement and silica coupler together with a specified combination of zinc oxide and long chain (fatty) carboxylic acid such as stearic acid. The silica, silica coupling agent, zinc oxide and stearic acid are combined in a manner to form a complex network. The silica is a precipitated silica in a form of silica aggregates which contain hydroxyl groups on its surface. A preferred silica coupling agent is a bis (3-trialkoxysilylalkyl) polysulfide which contains an average of from 2 to about 4, preferably from 2 to about 2.6, connecting sulfur atoms in its polysulfidic bridge. The invention further relates to tires having a component thereof such as, for example, a tread.

### BACKGROUND OF THE INVENTION

Various rubber compositions for components for various products, such as for example tires, contain particulate reinforcement comprised of a combination of precipitated silica and rubber reinforcing carbon black together with a coupling agent for the silica. Such rubber compositions also conventionally contain a combination of zinc oxide and stearic acid additives.

Various coupling agents have been proposed for coupling the precipitated silica to the diene-based elastomer for such rubber compositions.

Coupling agents have been proposed such as, for example, bis (3-trialkoxysilylalkyl) polysulfides which contain an average of from about 2 to about 4 connecting sulfur atoms in their polysulfidic bridge such as for example those comprised of bis(3-triethoxysilylpropyl) polysulfide.

Various alkoxyorganomercaptosilanes have also been proposed for such coupling agents in which their mercapto moiety is chemically capped, or blocked, to retard generation of increased viscosity buildup in the non-productive mixing of the rubber composition. The rubber composition conventionally contains an unblocking agent to unblock the mercapto moiety to enable the coupling agent to interact with a diene-based elastomer in the rubber composition. Such unblocking agent may be, for example, an amine-containing sulfur cure accelerator added in a non-productive or productive mixing stage.

However, such capped (or blocked) alkoxyorganomercaptosilanes are typically significantly more expensive than bis(3-trialkoxysilylalkyl) polysulfides comprised of, for example, a bis(3-triethoxysilylpropyl) polysulfide and therefor add a significant cost to the rubber composition itself.

Accordingly, it is desired herein to utilize a bis(3-trialkoxysilylalkyl) polysulfide as a coupling agent in a manner which does not excessively increase the mixing viscosity of the rubber composition yet can yield various physical properties of the resultant rubber composition similar to the use of such capped (or blocked) alkoxyorganomercaptosilane coupling agent.

As hereinbefore indicated, diene-based elastomer compositions typically contain a combination of zinc oxide and long chain carboxylic (fatty) acid such as, for example, stearic acid. The combination of zinc oxide and fatty acid typically forms a zinc fatty acid salt (e.g. zinc stearate) in situ within the rubber composition to act as a sulfur vulcanization promoter for sulfur vulcanization of diene-based elastomers.

For this invention it has been found unexpectedly, that by controlled sequential addition of a combination of a threshold amount of zinc oxide and an excess of carboxylic fatty acid (molar excess in the sense of providing an excess amount of the fatty acid to produce the zinc salt of the fatty acid, such as for example, zinc stearate, in situ within the rubber composition), a structured complex network is apparently created between zinc stearate, the bis(3-trialkoxysilylalkyl) polysulfide based coupling agent and the precipitated silica-rich diene-based elastomer rubber composition during the mixing process as evidenced by significantly reduced viscosity (e.g. Mooney viscosity) and various physical properties obtained for the resultant rubber composition.

In practice the long chain carboxylic (fatty) acid for use in preparation of rubber compositions is typically referred to as “stearic acid” although it is typically comprised primarily of stearic acid and contains minor amounts (less than 10 weight percent) of long chain carboxylic acids comprised of palmitic acid and oleic acid.

In practice the said bis(3-trialkoxysilylalkyl) polysulfide coupling agent contains an average in a range of from 2 to 4, preferably an average in the range of from about 2 to about 2.6, connecting sulfur atoms in its polysulfidic bridge. The said bis(3-trialkoxysilylalkyl) polysulfide coupling agent is typically a bis(3-triethoxysilylpropyl) polysulfide. Exemplary of such coupling agent understood to be comprised of a bis(3-triethoxysilylpropyl) polysulfide coupling having an average of from about 2 to about 2.6 connecting sulfur atoms in its polysulfidic bridge is, for example, Si266™ from Degussa GmbH.

In practice, sulfur vulcanized elastomer products are typically prepared by thermomechanically mixing rubber and various ingredients in a sequentially step-wise manner followed by shaping and curing the compounded rubber to form a vulcanized product.

First, for the aforesaid mixing of the rubber and various ingredients, typically exclusive of sulfur and sulfur vulcanization accelerators, the elastomer(s) and various rubber compounding ingredients are typically blended in one or more non-productive thermomechanical mixing stage(s) in suitable mixers. Such non-productive mixing is usually conducted at temperatures in a range of about 140° C. to 190° C. and often in a range of about 150° C. to 180° C.

Following such non-productive mixing stage, or stages, in a final mixing stage, sometimes referred to as a productive mix stage, sulfur and sulfur vulcanization accelerators (curatives), and sometimes optionally one or more additional ingredients, are mixed with the rubber compound, or composition, typically at a significantly lower temperature in a range of about 100° C. to about 120° C., which is a lower temperature than the temperatures utilized in the non-productive mix stages in order to prevent or retard premature curing of the sulfur curable rubber, which is sometimes referred to as scorching, of the rubber composition.

The rubber mixture, sometimes referred to as a rubber compound or composition, is typically allowed to cool, sometimes before or after intermediate mill mixing of the rubber composition, between the aforesaid various mixing steps, for example, to a temperature below 50° C.

Such sequential non-productive mixing steps, including the intermediary mill mixing steps and the concluding final productive mixing step are well known to those having skill in the rubber mixing art.

By thermomechanical mixing, it is meant that the rubber compound, or composition of rubber and rubber compounding ingredients, is mixed in a rubber mixture under high shear conditions where the mixture autogeneously heats up, with an accompanying temperature rise, as a result of the mixing primarily due to shear and associated friction within the rubber mixture in the rubber mixer.

For this invention, it is proposed to have at least one and preferably at least two, sequential non-productive (NP) mixing stages, or steps, usually in an internal rubber mixer, at elevated temperatures followed by a productive (PR) mixing stage at a lower temperature.

This invention is focused on the use of such bis(3-trialkoxysilylalkyl) polysulfide based coupling agents for a silica (e.g. precipitated silica) containing diene-based elastomer rubber composition in combination with the use of a specified combination of zinc oxide and fatty acid comprised of stearic acid.

It is considered herein that a significant aspect of this invention is the use of specific amounts of zinc oxide and stearic acid in silica-containing (e.g. precipitated silica) diene-based elastomer rubber compositions.

It is considered herein that such aspect of this invention involves use of abnormal amounts of the stearic acid in conjunction with more normal amounts of zinc oxide wherein both the zinc oxide and stearic acid are added to the rubber composition in the same non-productive mixing stage, and therefore allowed to react together in situ within the rubber composition to form zinc stearate, in the aforesaid higher temperature non-productive mixing stage(s) prior to the aforesaid lower temperature productive mixing stage.

It is considered herein that such aspect of the invention is therefor a significant departure from past practice of more conventional preparation of silica-containing rubber composition with a combination of zinc oxide and lower levels of stearic acid (usually less than the levels of zinc oxide).

The term “phr” as used herein, and according to conventional practice, refers to “parts of a respective material per 100 parts by weight of rubber, or elastomer”.

In the description of this invention, the terms “rubber” and “elastomer” if used herein, may be used interchangeably, unless otherwise prescribed. The terms such as “rubber composition”, “compounded rubber” and “rubber compound”, if used herein, are used interchangeably to refer to rubber which has been blended or mixed with various ingredients and materials and “rubber compounding” or “compounding” may be used to refer to the mixing of such materials. Such terms are well known to those having skill in the rubber mixing or rubber compounding art.

### SUMMARY AND PRACTICE OF THE INVENTION

In accordance with this invention, a method of preparing a rubber composition comprises the sequential steps of, based upon parts by weight per 100 parts by weight rubber (phr):

(A) thernomechanically mixing in at least one non-productive mixing step in an internal rubber mixer to a temperature in a range of about 140° C. to about 190° C., alternatively in a range of about 150° C. to about 180° C., (such as for example, for a total collective non-productive mixing step time of about 2 to about 20, alternatively about 4 to about 15, minutes) for such mixing step(s):
(1) 100 parts by weight of at least one sulfur vulcanizable elastomer selected from conjugated diene homopolymers and copolymers and copolymers of vinyl aromatic compound (e.g. styrene) and at least one conjugated diene;
(2) about 15 to about 120, alternatively about 30 to about 110, phr of particulate reinforcing filler comprised of precipitated silica and rubber reinforcing carbon black, wherein said reinforcing filler contains from 55 to about 100, alternately from 75 to about 90, weight percent precipitated silica;
(3) at least one coupling agent comprised of a bis(3-trialkoxysilylalkyl) polysulfide having an average of from 2 to about 4, alternately an average of from 2 to about 2.6, connecting sulfur atoms in its polysulfidic bridge, and
(4) combination of zinc oxide and stearic acid composed of;
   (a) from 1 through 7 phr (inclusive) of zinc oxide and from 3 through 8 phr (inclusive) of stearic acid, or
   (b) from 1 through 3 phr (inclusive) of zinc oxide, and from 3 through 8 phr (inclusive) of stearic acid, or
   (c) from 1 through 3 phr (inclusive) of zinc oxide and from 3 through 5 phr (inclusive) of stearic acid;
wherein said zinc oxide and said stearic acid are mixed in the same non-productive mixing step in an internal rubber mixer; and

(B) subsequently blending therewith (blending with the resultant rubber of said non-productive mixing steps), in a final thermomechanical mixing step (productive mixing step) at a temperature in a range of about 100° C. to about 120° C., (for a period of, for example, about 1 to about 3 minutes), elemental sulfur and at least one sulfur vulcanization accelerator.

In one aspect, the weight ratio of said zinc oxide to said stearic acid is preferably at least 1/1 and more preferably in a range of from at least 1/1 to about 1.5/1.

In one aspect of the invention such process is provided wherein said non-productive mixing is conducted in at least two thermomechanical mixing steps, of which at least two of such mixing steps are conducted to a temperature in a range of about 140° C. to about 190° C., with intermediate cooling of the rubber composition between at least two of said mixing steps to a temperature below about 50° C.

A significant aspect of this invention is the use of coupling agent as a bis(3-triethoxysilylpropyl) polysulfide, having an average of from about 2 to about 4, preferably from about 2 to about 2.6 sulfur atoms in its polysulfidic bridge, in a precipitated silica-rich diene-based elastomer composition in the presence of the controlled combination of zinc oxide and stearic acid.

A further significant aspect of this invention is the requirement that said zinc oxide and said stearic acid are both in one of said non-productive steps (both mixed in a same non-productive mixing step) in an internal rubber mixer in the presence of the bis(3-triethoxysilylpropyl) polysulfide coupling agent instead of being added separately in separate non-productive mixing stages. The purpose is to ensure that the combination of the zinc oxide and stearic acid are present with the bis(3-triethoxysilylpropyl) polysulfide coupling agent in a same non-productive mixing step to allow a full effect of utilization of the required restrictive amounts of the zinc oxide and stearic acid. Such method is desired to prevent, for example, the stearic acid to be allowed to be selectively mixed with the bis(3-triethoxysilylproply) polysulfide in a non-productive mixing step to the absence of, or exclusion of, an addition of the zinc oxide in the same mixing step.

While a combination of zinc oxide and stearic acid are well known rubber compounding ingredients, it is considered herein that their aforesaid controlled addition in their required amounts with such well known bis(3-triethoxysilylproply) polysulfide coupling agent is novel and a departure from past practice.

Historically, it is considered herein that, for preparation of diene-based elastomer compositions, stearic acid is typically used in relatively limited amounts which is conventionally less (weight-wise) than the zinc oxide and thus in a weight ratio of stearic acid to zinc oxide of less than 1/1. This is considered herein to be because excess stearic acid tends to migrate to the surface of the rubber composition and create a surface bloom thereon with a resultant loss in surface tack of the uncured rubber composition and, further to inhibit or retard cured adhesion of the rubber composition to other rubber compositions (other rubber components).

However, in the case of a precipitated silica-rich diene-based elastomer composition, it is understood herein that such tendency of stearic acid to migrate to the rubber surface is reduced, or somewhat retarded or inhibited, apparently due to presence of the precipitated silica in the rubber composition.

As a result, it was found unexpectedly that by increasing the stearic acid content of the rubber composition, so long as a basic threshold, or amount, of the zinc oxide is present relative to the stearic acid, in the precipitated silica reinforced rubber composition which also contains the aforesaid bis(3-triethoxysilylpropyl) polysulfide silica coupling agent, the viscosity build up of the uncured rubber composition while being mixed in an internal rubber mixer is significantly retarded, particularly when the zinc oxide and stearic acid are added in the same mixing step and are therefore added in the presence of each other and the coupling agent instead of being added sequentially in separate individual mixing steps.

Indeed, such practice is believed to be a relatively simple but substantial and significant departure from past practice of utilizing well known rubber compound ingredients such as zinc oxide, stearic acid, precipitated silica and the bis(3-triethoxysilylpropyl) polysulfide coupling agent in a novel sequential manner to achieve sought after results, namely a reduced or retarded rubber viscosity built up during the mixing of the rubber composition in an internal rubber mixer.

In further accordance with this invention, a rubber composition is provided having been prepared by such method.

In further accordance with the invention, the process comprises the additional step of vulcanizing the prepared rubber composition at a temperature in a range of about 140° C. to about 190° C.

Accordingly, the invention also thereby contemplates a vulcanized rubber composition prepared by such process.

In additional accordance with the invention the process comprises the additional steps of preparing an assembly of a tire or sulfur vulcanizable rubber with a component (e.g. a tread) comprised of the said rubber composition prepared according to the process of this invention and vulcanizing the assembly at a temperature in a range of about 140° C. to about 190° C.

Accordingly, the invention also thereby contemplates a vulcanized tire prepared by such process.

In the practice of this invention, as hereinbefore pointed out, the rubber composition is comprised of at least one diene-based elastomer, or rubber. Suitable conjugated dienes are isoprene and 1,3-butadiene and suitable vinyl aromatic compounds are styrene and alpha methyl styrene. Thus, it is considered that the elastomer is a sulfur curable elastomer. Such diene based elastomer, or rubber, may be selected, for example, from at least one of cis 1,4-polyisoprene rubber (natural and/or synthetic), and preferably natural rubber, emulsion polymerization prepared styrene/butadiene copolymer rubber, organic solution polymerization prepared styrene/butadiene rubber, 3,4-polyisoprene rubber, isoprene/butadiene rubber, styrene/isoprene/butadiene terpolymer rubbers, cis 1,4-polybutadiene, medium vinyl polybutadiene rubber (35 to 50 percent vinyl), high vinyl polybutadiene rubber (50 to 90 percent vinyl), styrene/isoprene copolymers, emulsion polymerization prepared styrene/butadiene/acrylonitrile terpolymer rubber and butadiene/acrylonitrile copolymer rubber.

Other and additional diene-based elastomers include specialized solution polymerization prepared high vinyl styrene/butadiene copolymer rubber (HV-S-SBR) having a bound styrene content in a range of about 5 to about 45 percent and a vinyl 1,2-content based upon its polybutadiene portion in a range of from about 30 to about 90 percent, particularly such (HV-S-SBR) having a relatively high onset high glass transition (Tg) value in a range of from about −20° C. to about −40° C. to promote a suitable wet traction for the tire tread and also a relatively high hot rebound value (100° C.) to promote a relatively low rolling resistance for the tread rubber composition intended for relatively heavy duty use. Such specialized high vinyl styrene/butadiene rubber (HV-S-SBR) might be prepared, for example, by polymerization in an organic solution of styrene and 1,3-butadiene monomers to include a chemical modification of polymer chain endings and to promote formation of vinyl 1,2-groups on the butadiene portion of the copolymer. A HV-S-SBR may be, for example, Duradene 738™ from Firestone/Bridgestone.

Other and additional elastomers are functionalized styrene/butadiene copolymer elastomers (functionalized SBR elastomers) containing amine and/or siloxy (e.g. alkoxyl silane as SiOR) functional groups.

Representative of such amine functionalized SBR elastomers is, for example, SLR4601™ from Dow Chemical and T5560™ from JSR, and in-chain amine functionalized SBR elastomers mentioned in U.S. Pat. Nos. 6,735,447 and 6,936,669.

Representative of such siloxy functionalized SBR elastomers is, for example, SLR4610™ from Dow Chemical.

Representative of such combination of amine and siloxy functionalized SBR elastomers is, for example, HPR350™ from JSR.

Other and additional elastomers are functionalized styrene/butadiene copolymer elastomers (functionalized SBR elastomers) containing hydroxy or epoxy functional groups.

Representative of such hydroxy functionalized SBR elastomers is, for example, Tufdene 3330™ from Asahi.

Representative of such epoxy functionalized SBR elastomers is, for example, Tufdene E50 T from Asahi.

In practice, it is therefore envisioned that said sulfur vulcanizable elastomer may be comprised of, for example, polymers of at least one of isoprene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers comprised of styrene and 1,3-butadiene (“functionalized SBR”) selected from amine functionalized SBR, siloxy functionalized SBR, combination of amine and siloxy functionalized SBR, epoxy functionalized SBR and hydroxy functionalized SBR.

The siliceous pigments preferably employed in this invention are precipitated silicas such as, for example, those obtained by the acidification of a soluble silicate, e.g., sodium silicate. Such precipitated silicas are well known to those having skill in such art.

Such precipitated silicas might have, for example, a BET surface area, as measured using nitrogen gas, preferably in the range of about 40 to about 600, and more usually in a range of about 50 to about 300 square meters per gram. A BET method of measuring surface area is described in the Journal of the American Chemical Society, Volume 60, understood to include Page 308 in the year 1938.

The silica may also have, for example, a dibutylphthalate (DBP) absorption value in a range of about 100 to about 350, and more usually about 150 to about 300 cc/100 gm.

Various commercially available silicas may be used, for example, only for example herein, and without limitation, silicas commercially available from PPG Industries under the Hi-Sil™ with designations Hi-Sil 210, 243, etc; silicas available from Rhone-Poulenc, with, for example, designation of Zeosil 1165 MP, silicas available from Degussa GmbH with, for example, designations VN2 and VN3, etc and silicas commercially available from Huber having, for example, a designation of Hubersil 8745.

It is readily understood by those having skill in the art that the rubber composition would be compounded by methods generally known in the rubber compounding art, such as mixing the various sulfur-vulcanizable constituent rubbers with various commonly used additive materials such as, for example, curing aids, such as sulfur, activators, retarders and accelerators, processing additives, such as oils, resins including tackifying resins and plasticizers, fillers, pigments, waxes, antioxidants and antiozonants. As known to those skilled in the art, depending on the intended use of the sulfur vulcanizable and sulfur vulcanized material (rubbers), the additives mentioned above are selected and commonly used in conventional amounts.

Typical amounts of tackifier resins, if used, may comprise, for example, from about 1 to about 10 phr, for example, about 1 to about 5 phr. Typical amounts of processing aids may comprise, for example, about 1 to about 50 phr. Such processing aids can include, for example, aromatic, napthenic, and/or paraffinic processing oils. Typical amounts of antioxidants may comprise, for example, about 1 to about 5 phr. Representative antioxidants may be, for example, diphenyl-p-phenylenediamine and others, such as, for example, those disclosed in the Vanderbilt Rubber Handbook (1978), Pages 344 through 346. Typical amounts of antiozonants may comprise, for example, from about 1 to 5 phr. Typical amounts of waxes, if used, may comprise for example from about 1 to about 5 phr. Often microcrystalline waxes are used. Typical amounts of peptizers if used may comprise for example about 0.1 to about 1 phr. Typical peptizers may be, for example, pentachlorothiophenol and dibenzamidodiphenyl disulfide.

The vulcanization is conducted in the presence of a sulfur vulcanizing agent. Examples of suitable sulfur vulcanizing agents include, for example, elemental sulfur (free sulfur) or sulfur donating vulcanizing agents, for example, an amine disulfide, polymeric polysulfide or sulfur olefin adducts which are conventionally added in the final, productive, rubber composition mixing step. Preferably, in most cases, the sulfur vulcanizing agent is elemental sulfur. As known to those skilled in the art, sulfur vulcanizing agents are used, or added in the productive mixing stage, in an amount ranging, for example, from about 0.4 to about 3 phr, or even, in some circumstances, up to about 8 phr, with a range of from about 1.5 to about 2.5, sometimes from 2 to 2.5, being usually preferred.

Accelerators are used to control the time and/or temperature required for vulcanization and to improve the properties of the vulcanizate. In one embodiment, a single accelerator system may be used, i.e., primary accelerator. Conventionally and preferably, a primary accelerator(s) is used in total amounts ranging from, for example, about 0.5 to about 4, preferably about 0.8 to about 1.5, phr. In another embodiment, combinations of a primary and a secondary accelerator might be used with the secondary accelerator being used in smaller amounts (for example, about 0.05 to about 3 phr) in order to activate and to improve the properties of the vulcanizate. Combinations of these accelerators might be expected to produce a synergistic effect on the final properties and are somewhat better than those produced by use of either accelerator alone. In addition, delayed action accelerators may be used which are not affected by normal processing temperatures but produce a satisfactory cure at ordinary vulcanization temperatures. Vulcanization retarders might also be used. Suitable types of accelerators that may be used in the present invention are, for example, amines, disulfides, guanidines, thioureas, thiazoles, thiurams, sulfenamides, dithiocarbamates and xanthates. Preferably, the primary accelerator is a sulfenamide. If a second accelerator is used, the secondary accelerator is preferably a guanidine, dithiocarbamate or thiuram compound.

The silica-containing rubber composition of this invention can be used for various purposes. For example, it can be used for various tire components such as for example, treads, sidewall, ply coat and wire coat rubber compositions. Such tires can be built, shaped, molded and cured by various methods which are known and will be readily apparent to those having skill in such art.

The invention may be better understood by reference to the following examples in which the parts and percentages are by weight unless otherwise indicated.

### EXAMPLE I

Sulfur vulcanizable rubber mixtures containing silica reinforcement were prepared utilizing a silica coupler and a combination of zinc oxide and stearic acid.

Rubber Samples A through G contained various amounts of zinc oxide and stearic acid as indicated in Table 1 and Table 2.

The basic rubber composition formulation is presented in Table 1 and the ingredients are expressed in terms of weight, namely parts by weight (phr) unless otherwise indicated.

The rubber compositions were prepared by mixing the elastomers(s) together with reinforcing fillers, coupling agents and other rubber compounding ingredients in a first non-productive mixing stage (NP-1) in an internal rubber mixer for about 4 minutes to a temperature of about 160° C. The rubber mixture is then mixed in a second non-productive mixing stage (NP-2) in an internal rubber mixer for about 4 minutes to a temperature of about 160° C. without adding additional ingredients. The resulting rubber mixture is then mixed in a productive mixing stage (PR) in an internal rubber mixer with sulfur curatives for about 2 minutes to a temperature of about 110° C. The rubber composition is sheeted out and cooled to below 50° C. between each of the non-productive mixing steps and prior to the productive mixing step.

TABLE 1

| | Parts |
|---|---|
| Non-Productive Mixing (NP-1) | |
| E-SBR (styrene/butadiene rubber)¹ | 27.5 (20 parts rubber and |
| | 7.5 parts oil) |
| High vinyl polybutadiene rubber² | 60 (50 parts rubber, 10 parts oil) |
| Cis 1,4-polybutadiene rubber³ | 20 |
| Cis 1,4-polyisoprene natural rubber | 10 |
| Silica⁴ | 76 |
| Coupling agent⁵ | 12 (6 parts coupler, 6 parts |
| | carbon black) |
| Rubber processing oil and | 10.5 |
| microcrystalline wax | |
| Zinc oxide | 2.5 to 5.5 (variable) |
| Stearic acid⁶ | 1 to 5 (variable) |
| Non-Productive Mixing (NP-2) | |
| No ingredients added | |
| Productive Mixing (PR) | |
| Sulfur | 2.2 |
| Accelerator(s)⁷ | 3.6 |

¹Emusion polymerization prepared styrene/butadiene copolymer rubber obtained from The Goodyear Tire & Rubber Company containing about 40 weight percent bound styrene and composed of 37.5 parts by weight rubber processing oil.
²High vinyl polybutadiene rubber obtained from The Goodyear Tire & Rubber Company having a vinyl content of about 65 percent and composed of 20 parts by weight rubber processing oil.
³Cis 1,4-polybutadiene rubber obtained as BUD1207 ™ from the Goodyear Tire & Rubber Company
⁴Precipitated silica as 1165MP ™ from Rhodia
⁵Coupling agent as Si266 ™ from Degussa as a composite of a 50/50 weight ratio of carbon black and coupling agent comprised of a bis(3-triethoxysilylpropyl) polysulfide having an average in a range of from about 2 to about 2.6 connecting sulfur atoms in its polysulfidic bridge and reported in Table 1 in terms of the composite.
⁶Stearic acid comprised of at least 90 weight percent of stearic acid and a minor amount of other fatty acids comprised of palmitic and oleic acids
⁷Sulfenamide and guanidine based sulfur cure accelerators

The following Table 2 illustrates cure behavior and various physical properties of rubber Samples A through G which contain various amounts of said zinc oxide and stearic acid expressed in terms of weight (phr). Where a cured rubber sample was evaluated, such as for the stress-strain, rebound, hardness, tear strength and abrasion measurements, the rubber sample was cured for about 14 minutes at a temperature of about 160° C.

TABLE 2

| | Samples | | | | | | |
|---|---|---|---|---|---|---|---|
| | A | B | C | D | E | F | G |
| Zinc oxide | 2.5 | 2.5 | 5.5 | 5.5 | 5.5 | 4 | 2.5 |
| Stearic acid | 5 | 3 | 5 | 3 | 1 | 3 | 1 |
| Ratio of stearic acid/zinc oxide | 2 | 1.2 | 0.91 | 0.55 | 0.18 | 0.75 | 0.4 |
| RPA, 100° C., 1 Hz¹ Storage modulus G′ | | | | | | | |
| Uncured, kPa | 162 | 185 | 162 | 183 | 226 | 184 | 234 |
| Cured, 10% strain, kPa | 1789 | 2001 | 1787 | 2003 | 2434 | 2057 | 2382 |
| Cured, 50% strain, kPa | 1045 | 1104 | 1068 | 1118 | 1168 | 1141 | 1166 |
| Tan delta at 10% strain | 0.114 | 0.119 | 0.113 | 0.125 | 0.136 | 0.123 | 0.129 |
| Rheometer, 150° C. (MDR)² | | | | | | | |
| Maximum torque (dNm) | 19.2 | 21.25 | 20.64 | 21.71 | 25.47 | 22.16 | 24.86 |
| Minimum torque (dNm) | 2.14 | 2.59 | 2.1 | 2.49 | 3.56 | 2.57 | 3.76 |
| Delta torque (dNm) | 17.06 | 18.66 | 18.54 | 19.22 | 21.91 | 19.59 | 21.1 |
| T₂₅, minutes | 9.21 | 9.2 | 10.62 | 10.31 | 8.46 | 9.99 | 8.18 |
| T₉₀, minutes | 16.87 | 16.83 | 20.29 | 19.51 | 16.68 | 18.42 | 15.58 |
| Stress-strain (ATS)³ | | | | | | | |
| Tensile strength (MPa) | 14.3 | 14.0 | 12.9 | 14.2 | 14.5 | 14.22 | 15.81 |
| Elongation at break (%) | 439 | 403 | 424 | 416 | 393 | 398 | 406 |
| 100% modulus (MPa) | 2.2 | 2.17 | 2.25 | 2.19 | 2.23 | 2.31 | 2.25 |
| 300% modulus (MPa) | 9.68 | 10.41 | 9.17 | 10.22 | 11.02 | 10.85 | 11.53 |
| Hardness (Shore A), 100° C. | 63 | 64 | 64 | 65 | 68 | 65 | 67 |
| Rebound, 100° C. | 63 | 62 | 63 | 62 | 59 | 62 | 59 |
| DIN Abrasion (2.5N, cc rel loss)⁴ | 144 | 137 | 164 | 139 | 130 | 150 | 137 |

¹Data according to Rubber Process Analyzer as RPA 2000 ™ instrument by Alpha Technologies, formerly the Flexsys Company and formerly the Monsanto Company. References to an RPA-2000 instrument may be found in the following publications: H. A. Palowski, et al, Rubber World, June 1992 and January 1997, as well as Rubber & Plastics News, Apr. 26 and May 10, 1993.
²Data according to Moving Die Rheometer instrument, model MDR-2000 by Alpha Technologies, used for determining cure characteristics of elastomeric materials, such as for example. Torque, T25, etc.
³Data according to Automated Testing System instrument by the Instron Corporation which incorporates six tests in one system. Such instrument may determine ultimate tensile, ultimate elongation, modulii, etc. Data reported in the Table is generated by running the ring tensile test station which is an Instron 4201 load frame.
⁴Data according to DIN 53516 abrasion resistance test procedure using a Zwick drum abrasion unit, model 6102 with 2.5 Newtons force. DIN standards are German test standards. The DIN abrasion results are reported as relative values to a control rubber composition used by the laboratory.

From Table 2, and FIGS. 1 and 2, it can be seen that increasing levels of stearic acid, regardless of, and somewhat independent of, the level of zinc oxide used, provide a significant reduction of uncured G′ and Mooney viscosity of the uncured silica-rich rubber composition which contains the bis(3-triethoxysilylpropyl) polysulfide coupling agent which is the primary focus of this invention as previously discussed. Accordingly, it is evident that 2.5 phr of zinc oxide is just as effective as using an increased level of 5.5 phr of zinc oxide and that is it evident that using the enabled reduced amount of zinc oxide presents a cost reduction advantage.

It can also be seen that from Table 2 and FIGS. 3 and 4 that higher levels of stearic acid provided reduced hysteresis of the cured rubber composition as shown by a lower tan delta value, a positive direction to promote a reduction in heat generation and buildup while dynamically working a tire component of such rubber composition.

However, at the highest level of stearic acid, namely about 5 phr of stearic acid, regardless of the level of zinc oxide (e.g. from 2.5 to 5 phr) a reduction of cured stiffness (e.g. storage modulus G′ property) is observed to begin to occur which is considered herein to be a negative effect and therefore tends to be a limitive effect on the stearic acid content. The stiffness of the rubber composition is considered herein to be desirable to maintain a suitable balance of the aforesaid hysteresis of the rubber and its stiffness for a tire tread rubber composition.

It is considered herein to be important to promote a balance between uncured viscosity (e.g. Mooney viscosity) and cured stiffness (e.g. storage modulus G′ property) as well as hysteresis (e.g. tan delta property).

Accordingly, for the purposes of this invention, an upper level of about 8, more preferably 5, phr of the stearic acid is considered to be desirable for the silica-rich rubber composition which contains the bis(3-triethoxysilylpropyl) coupling agent.

As a result, it is considered herein that such results indicate a suitable uncured viscosity (Mooney viscosity) reduction and reduced cured hysteresis of such rubber composition can occur when using the higher levels of stearic acid, which tended to be limited when taking into account a reduced cured stiffness beginning to occur at higher levels of stearic acid content, as hereinbefore discussed, to therefore suggest an optimum and more preferred level for the stearic acid in such rubber composition of from about 3 to 5 phr.

### BRIEF DESCRIPTION OF THE DRAWINGS

For a further understanding of the invention, drawings are provided as FIGURES (FIG. 1 through FIG. 4) as graphical plots of stearic acid versus zinc oxide contents together with selected uncured and cured physical properties of the rubber composition Samples of Table 2.

FIG. 1 through FIG. 4 contain Box A, Box B and Box C, with individual zinc oxide and stearic acid parameters for each of the Boxes.

### THE DRAWINGS

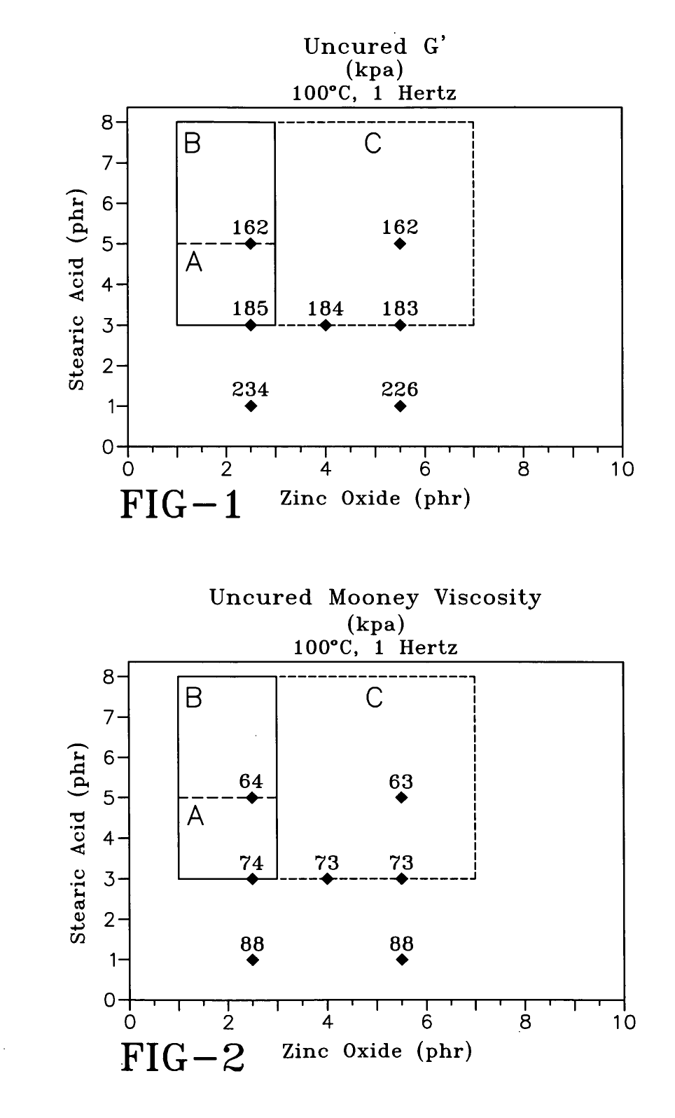

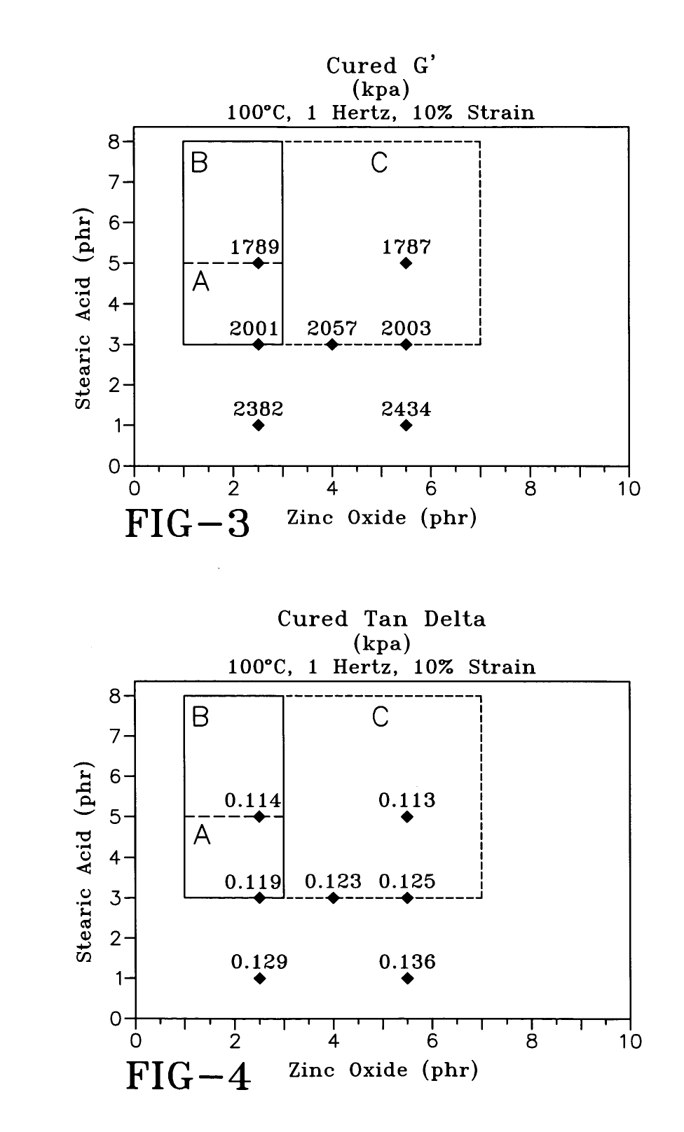

For the drawings, FIG. 1 and FIG. 2 report uncured physical properties as G′ values for FIG. 1 and Mooney viscosities for FIG. 2 of the rubber Samples from data reported in Table 2. For the drawings, FIG. 3 and FIG. 4 report cured physical properties as G′ values for FIG. 3 and tan delta values for FIG. 4 of the rubber samples from data reported in Table 2.

Box A of the FIGURES represents the area bounded by the most preferred and limitive combination of 1 through 3 phr for the zinc oxide and 3 through 5 phr for the stearic acid.

Box B of the FIGURES represents a somewhat enlarged the area (as compared to Box A) bounded by a somewhat enlarged combination of 1 through 3 phr for the zinc oxide and 3 through 8 phr for the stearic acid.

Box C of the FIGURES represents an enlarged area bounded by the broader combination of 1 through 7 phr for the zinc oxide and 3 through 8 phr for the stearic acid.

In one limitive aspect of the invention not illustrated by but contained within the aforesaid boundaries of Box A, Box B and Box C of the FIGURES, the weight ratio of stearic acid to zinc oxide is preferably at least 1/1 (e.g. a weight ratio of 1/1 or greater).

### EXAMPLE II

Sulfur vulcanizable rubber mixtures containing silica reinforcement were prepared in a manner similar to Example I utilizing a silica coupler and a combination of zinc oxide and stearic acid based long chain (fatty) carboxylic acid.

The silica coupler was an alkoxyorganomercaptosilane having its mercapto moiety blocked (Silica coupling agent A) for Sample H, or bis(3-triethoxysilylpropyl) polysulfide (Silica coupling agent B) for Samples I and J.

The ingredients are illustrated in the following Table 3 and expressed in terms of weight (parts or phr) or weight percent unless otherwise indicated.

TABLE 3

| | Control | | |
|---|---|---|---|
| | Sample H | Sample I | Sample J |
| Non-Productive Mixing (NP-1) | | | |
| SSBR (styrene/butadiene rubber)¹ | 60 | 60 | 60 |
| Cis 1,4-polybutadiene rubber, | 50 | 50 | 50 |
| oil extended)² | | | |
| Carbon black³ | 6.4 | 6.4 | 6.4 |
| Silica⁴ | 80 | 80 | 80 |
| Coupling agent A | 6.4 | 0 | 0 |
| (alkoxyorganomercaptosilane)⁵ | | | |
| Coupling agent B, | 0 | 6.4 | 6.4 |
| bis(3-triethoxysilylpropyl | | | |
| polysulfide)⁶ | | | |
| Zinc oxide | 3 | 3 | 6 |
| Stearic acid⁷ | 2 | 2 | 4 |
| Stearic acid/zinc oxide ratio | 0.67 | 0.67 | 0.67 |
| Antidegradant⁸ | 1 | 1 | 1 |
| Rubber processing oil | 11.3 | 11.3 | 11.3 |
| Non-Productive Mixing (NP-2 | | | |
| No ingredients added | | | |
| Productive Mixing (PR) | | | |
| Sulfur | 2 | 1.9 | 2.1 |
| Accelerator(s)⁹ | 3.9 | 3.8 | 4.0 |

¹Solution polymerization prepared styrene/butadiene rubber as Solflex 28X42 ™ from The Goodyear Tire & Rubber Company
²Obtained as BUD1254 ™ from The Goodyear Tire & Rubber Company as an oil extended cis 1,4-polybutadiene rubber composed of 100 parts rubber and 25 parts rubber processing oil (40 parts rubber plus 10 parts oil)
³ASTM N-330, an ASTM designation for a rubber reinforcing carbon black
⁴Precipitated silica as said 1165 ™ from Rhodia
⁵Coupling agent as NXT ™ from GE Silicones, as an alkoxyorganomercaptosilane having its mercapto moiety blocked
⁶Coupling agent as said Si266 ™ from Degussa.
⁷Stearic acid comprised primarily of stearic acid (at least 90 weight percent stearic acid and a minor amount of other organic carboxylic acids comprised of palmitic and oleic acids) and referred to herein as “stearic acid”
⁸Of the p-phenylenediamine type
⁹Sulfenamide and guanidine based sulfur cure accelerators

The following Table 4 illustrates cure behavior and various physical properties of the rubber Samples obtained in the manner of Example I.

TABLE 4

| | Control | | |
|---|---|---|---|
| | Sample H | Sample I | Sample J |
| Material Summary | | | |
| Coupling agent A, | 6.4 | 0 | 0 |
| alkoxyorganomercaptosilane | | | |
| Coupling agent B, | 0 | 6.4 | 6.4 |
| bis(3-triethoxysilylpropyl) | | | |
| polysulfide | | | |
| Zinc oxide | 3 | 3 | 6 |
| Stearic acid | 2 | 2 | 4 |
| Weight ratio of stearic acid | 0.67 | 0.67 | 0.67 |
| to zinc oxide | | | |
| Physical Properties | | | |
| Rheometer, 160° C. (MDR)¹ | | | |
| Maximum torque (dNm) | 17 | 19.5 | 15.6 |
| Minimum torque (dNm) | 2.1 | 2.8 | 1.7 |
| Delta torque (dNm) | 14.9 | 16.7 | 13.9 |
| T90 (minutes) | 7.7 | 7.9 | 10.8 |
| Stress-strain (ATS)² | | | |
| Tensile strength (MPa) | 17.3 | 16.7 | 16.5 |
| Elongation at break (%) | 512 | 470 | 491 |
| 300% modulus (MPa) | 8.7 | 9.3 | 9.1 |
| Rebound, % 100° C. | 61.9 | 58.2 | 61 |
| Hardness (Shore A) 100° C. | 58.3 | 61 | 59.3 |
| RPA, 100° C.³ | | | |
| G′, uncured, 0.833 Hz, (kPa) | 146 | 241 | 128 |
| Tan delta (cured) 10% strain 1 Hz | 0.12 | 0.14 | 0.13 |
| Mooney viscosity (ML 1 + 4), | 58 | 71 | 51 |
| (100° C.) | | | |
| DIN abrasion (2.5N, cc relative | 148 | 148 | 154 |
| loss)⁴ | | | |

The footnoted (superscripted) physical test procedures in Table 4 are those reported for the aforesaid Table 2 of Example I.

From Table 4 it can be seen that the use of 3 phr of zinc oxide and 2 phr of stearic acid when used in the silica-rich rubber composition with the alkoxyorganomercaptosilane coupling agent (Coupling agent “A”) in rubber Sample H provided a low uncured viscosity (Mooney viscosity value of 58) and low uncured modulus G′ (G′ value of 146 kPa).

However, the use of the same levels of zinc oxide (3 phr) and stearic acid (2 phr) in a silica-rich rubber composition with the bis(3-triethoxysilylpropyl) disulfide coupling agent (Coupling agent “B”) in rubber Sample I provided a significantly higher uncured viscosity (Mooney viscosity value of 71) and uncured modulus G′ (G′ value of 241 kPa).

In contrast, for rubber Sample J, the use of the coupling agent B, bis(3-triethoxysilylpropyl) polysulfide, with an increased level of the zinc oxide (level of 6 phr) and stearic acid (4 phr), the uncured viscosity (Mooney viscosity value of 51) was significantly reduced as well as the modulus G′ (modulus G′ value of 128 kPa).

This behavior was also observed in Example I with an increasing level of stearic acid and the results from Example I would suggest that the zinc oxide level could be reduced to much lower levels (e.g. to levels of 3 phr or less) for a cost savings without losing the aforesaid uncured rubber viscosity (Mooney viscosity) benefit.

It is also apparent from Table 4 that the low uncured rubber viscosity (Mooney viscosity) is obtained in rubber Sample J without a sacrifice of other indicated cured rubber physical properties.

Accordingly, such results show the ability to achieve substantially equal performance (physical properties) in the silica-rich, diene-based rubber compositions with a lower cost coupling agent, namely the bis(3-triethoxysilylpropyl) polysulfide coupling agent, in place of the significantly more costly and somewhat different chemistry oriented alkoxyorganomercaptosilane coupling agent while achieving the uncured rubber viscosity benefit by the inclusion of the controlled amounts of a combination of zinc oxide and stearic acid in which both of the zinc oxide and stearic acid are blended with the rubber composition in the same mixing step.

### EXAMPLE III

Sulfur vulcanizable rubber mixtures containing silica reinforcement were prepared in a manner similar to Example I which contained a combination of zinc oxide and stearic acid, (Samples K and L), and a combination of zinc oxide, stearic acid and zinc soap (Sample M).

The ingredients are illustrated in the following Table 5 and expressed in terms of weight (phr) or weight percent unless otherwise indicated.

TABLE 5

| | Control | | |
|---|---|---|---|
| | Sample K | Sample L | Sample M |
| Non-Productive Mixing (NP-1) | | | |
| SSBR (styrene/butadiene rubber)¹ | 60 | 60 | 60 |
| Cis 1,4-polybutadiene rubber² | 50 | 50 | 50 |
| Carbon black³ | 6.4 | 6.4 | 6.4 |
| Silica⁴ | 80 | 80 | 80 |
| Coupling agent A | 6.4 | 0 | 0 |
| (alkoxymercaptosilane)⁵ | | | |
| Coupling agent B, | 0 | 6.4 | 6.4 |
| bis(3-triethoxysilylpropyl) | | | |
| polysulfide⁶ | | | |
| Zinc oxide | 3 | 3 | 3 |
| Fatty Acid (stearic acid)⁷ | 2 | 2 | 2 |
| Zinc soap¹⁰ | 0 | 0 | 4 |
| Antidegradant⁸ | 4 | 4 | 4 |
| Rubber processing oil | 11.3 | 11.3 | 11.3 |
| Non-Productive Mixing (NP-2 | | | |
| No ingredients added | | | |
| Productive Mixing (PR) | | | |
| Sulfur | 2 | 1.9 | 2.05 |
| Accelerator(s)⁹ | 3.9 | 3.8 | 3.95 |

¹Obtained as Solflex 28X42 ™ from The Goodyear Tire & Rubber Company
²Obtained as BUD1254 ™ from The Goodyear Tire & Rubber Company in a form of 40 parts rubber plus 10 parts rubber processing oil
³ASTM N-330, an ASTM designation for a rubber reinforcing carbon black
⁴Precipitated silica as said 1165MP ™ from Rhodia
⁵Coupling agent as said Si266 ™ from Degussa
⁶Coupling agent as said NXT ™ from GE Silicones
⁷Fatty acid as stearic acid and a minor amount of other acids including palmitic and oleic acids
⁸Of the p-phenylenediamine type
⁹Sulfenamide and guanidine based sulfur cure accelerators
¹⁰Zinc soap as EF 44A ™ from the Struktol company, a proprietary zinc soap

The following Table 6 illustrates cure behavior and various physical properties of the rubber Samples expressed in terms of weight (phr) and weight percent except where otherwise indicated. Where a cured rubber sample was evaluated, such as for the stress-strain, rebound, hardness, tear strength and abrasion measurements, the rubber sample was cured for about 14 minutes at a temperature of about 160° C.

TABLE 6

| | Control | | |
|---|---|---|---|
| | Sample K | Sample L | Sample M |
| Material Summary | | | |
| Coupling agent A | 6.4 | 0 | 0 |
| (alkoxyorganomercaptosilane) | | | |
| Coupling agent B, | 0 | 6.4 | 6.4 |
| bis(3-triethoxysilylpropyl) | | | |
| polysulfide | | | |
| Zinc oxide | 3 | 3 | 3 |
| Fatty acid (stearic acid) | 2 | 2 | 2 |
| Zinc soap | 0 | 0 | 4 |
| Physical Properties | | | |
| Rheometer, 160° C. (MDR)¹ | | | |
| Maximum torque (dNm) | 17 | 19.5 | 14.5 |
| Minimum torque (dNm) | 2.1 | 2.8 | 1.6 |
| Delta torque (dNm) | 14.9 | 16.7 | 11.1 |
| T90 (minutes) | 7.7 | 7.9 | 11.1 |
| Stress-strain (ATS)² | | | |
| Tensile strength (MPa) | 17.5 | 16.7 | 14.5 |
| Elongation at break (%) | 512 | 470 | 484 |
| 300% modulus (MPa) | 8.7 | 9.3 | 8.3 |
| Rebound, % 100° C. | 61.9 | 58.2 | 59.8 |
| Hardness (Shore A) 100° C. | 58.3 | 61 | 58.9 |
| RPA, 100° C.³ | | | |
| G′, uncured, 0.833 Hz, (kPa) | 146 | 241 | 133 |
| Tan delta (cured) 10% strain 1 Hz | 0.12 | 0.14 | 0.15 |
| Mooney viscosity (ML 1 + 4), | 58.4 | 71.3 | 49.4 |
| (100° C.) | | | |
| DIN abrasion (2.5N, cc relative loss)⁴ | 148 | 148 | 169 |

The footnoted (superscripted) physical test procedures in Table 4 are those reported for the aforesaid Table 2 of Example I.

From Table 6 it can be seen that the processability of the silica-containing rubber compositions can be improved by use of the indicated combination of zinc oxide and stearic acid for the bis(3-ethoxysilylpropyl) polysulfide silica coupling agent having an average in a range of from about 2 to about 2.6 sulfur atoms in its polysulfidic bridge together with a conventional zinc soap processing aid.

This is considered herein to be significant in the sense of the uncured G′ and uncured Mooney viscosity properties of the rubber composition.

However, from Table 6 it can also be seen than the DIN abrasion value of the cured Sample M was very high, namely 169, as compared to Samples K and L. This is considered herein as meaning that the processability of the uncured rubber composition was obtained with the addition of the zinc soap at the expense of resistance to wear (the increased DIN abrasion value) of Sample M.

Sample M in which a combination of the zinc oxide, stearic acid and zinc soap is used shows a significantly lower tensile strength at break which is considered herein to be a negative impact upon the rubber Sample properties.

While certain representative embodiments and details have been shown for the purpose of illustrating the invention, it will be apparent to those skilled in this art that various changes and modifications may be made therein without departing from the spirit or scope of the invention.

What is claimed is:

1. A method of preparing a rubber composition which comprises the sequential steps of, based upon parts by weight per 100 parts by weight rubber (phr):
(A) thermomechanically mixing in at least one non-productive mixing step in an internal rubber mixer to a temperature in a range of about 140° C. to about 190° C.:
(1) 100 parts by weight of at least one sulfur vulcanizable elastomer selected from conjugated diene homopolymers and copolymers and copolymers of styrene and at least one conjugated diene;
(2) about 15 to about 120 phr of particulate reinforcing filler comprised of precipitated silica and rubber reinforcing carbon black, wherein said reinforcing filler contains from 55 to about 100 weight percent precipitated silica;
(3) at least one coupling agent comprised of a bis (3-triethoxysilylpropyl) polysulfide having an average of from 2 to about 4 connecting sulfur atoms in its polysulfidic bridge, and
(4) combination of zinc oxide and stearic acid composed of;
(a) from 1 through 7 phr of zinc oxide and from 3 through 8 phr of stearic acid, or
(b) from 1 through 3 phr of zinc oxide and from 3 through 8 phr of stearic acid, or
(c) from 1 through 3 phr of zinc oxide and from 3 through 5 phr of stearic acid;
wherein said zinc oxide and said stearic acid are mixed in the same non-productive mixing step in an internal rubber mixer; and
(B) subsequently blending therewith in a final thermomechanical mixing step at a temperature in a range of about 100° C. to about 120° C., elemental sulfur and at least one sulfur vulcanization accelerator.

2. The method of claim 1 wherein said combination of said zinc oxide and stearic acid is composed of from 1 through 7 phr of zinc oxide and from 3 through 8 phr of stearic acid.

3. The method of claim 1 wherein said combination of said zinc oxide and stearic acid is composed of from 1 through 3 phr of zinc oxide and from 3 through 8 phr of stearic acid.

4. The method of claim 1 wherein said combination of said zinc oxide and stearic acid is composed of from 1 through 3 phr of zinc oxide and from 3 through 5 phr of stearic acid.

5. The method of claim 1 wherein the weight ratio of said zinc oxide to said stearic acid is at least 1/1.

6. The method of claim 4 wherein the weight ratio of said zinc oxide to said stearic acid is in a range of from 1/1 to about 1.5.

7. The method of claim 5 wherein the weight ratio of said zinc oxide to said stearic acid is in a range of from 1/1 to about 1.5.

8. The method of claim 1 wherein said sulfur vulcanizable elastomer is comprised of polymers of at least one of isoporene and 1,3-butadiene; copolymers of styrene and at least one of isoprene and 1,3-butadiene; high vinyl styrene/butadiene elastomers having a vinyl 1,2-content based upon its polybutadiene in a range of from about 30 to 90 percent and functionalized copolymers of styrene and 1,3-butadiene (“functionalized SBR”) selected from amine functionalized SBR, siloxy functionalized SBR, combination of amine and siloxy functionalized SBR, epoxy functionalized SBR and hydroxy functionalized SBR.

9. The method of claim 1 wherein said non-productive mixing is conducted in at least two thermomechanical mixing steps, of which at least two of such mixing steps are conducted to a temperature in a range of about 140° C. to about 190° C., with intermediate cooling of the rubber composition between at least two of said mixing steps to a temperature below about 50° C.

10. A rubber composition prepared according to the method of claim 1 wherein said method additionally comprises vulcanizing the prepared rubber composition.

11. A rubber composition prepared according to the method of claim 2 wherein said method additionally comprises vulcanizing the prepared rubber composition.

12. A rubber composition prepared according to the method of claim 3 wherein said method additionally comprises vulcanizing the prepared rubber composition.

13. A rubber composition prepared according to the method of claim 4 wherein said method additionally comprises vulcanizing the prepared rubber composition.

14. A rubber composition prepared according to the method of claim 5 wherein said method additionally comprises vulcanizing the prepared rubber composition.

15. The method of claim 1 wherein said method additionally comprises preparing an assembly of a tire with a component comprised of the said rubber composition prepared according to said method and vulcanizing the assembly.

16. The method of claim 2 wherein said method additionally comprises preparing an assembly of a tire with a component comprised of the said rubber composition prepared according to said method and vulcanizing the assembly.

17. The method of claim 4 wherein said method additionally comprises preparing an assembly of a tire with a component comprised of the said rubber composition prepared according to said method and vulcanizing the assembly.

18. The method of claim 5 wherein said method additionally comprises preparing an assembly of a tire with a component comprised of the said rubber composition prepared according to said method and vulcanizing the assembly.

19. A tire prepared by the method of claim 15.

20. A tire prepared by the method of claim 18.
